(19) United States
(12) Patent Application Publication
(10) Pub. No.: US 2010/0005726 A1
(43) Pub. Date: Jan. 14, 2010

(54) Sliding Glass Door Panel

(75) Inventor: Frederick Keith Lomax, Rainier, WA (US)

Correspondence Address: LOEB & LOEB, LLP, 321 NORTH CLARK, SUITE 2300, CHICAGO, IL, 60654-4746, US

(73) Assignee: Classy Custom, Inc., Rainier, WA (US)

(21) Appl. No.: 12/499,659

(22) Filed: Jul. 8, 2009

Related U.S. Application Data
(60) Provisional application No. 61/078,860, filed on Jul. 8, 2008.

(51) Int. Cl. E05D 15/06

(52) U.S. Cl. 49/449; 49/404

(57) ABSTRACT

The present disclosure relates to a door panel for use with a preexisting sliding-type patio door. The door panel comprises an outer frame, an inner frame member, an upper panel and a connection between the outer frame and the preexisting sliding-type patio door. The connection between the outer frame and the preexisting sliding-type patio door may comprise one or more fasteners, a hinge mechanism, or a tongue-groove mating between the fame and the bottom track of the sliding-type patio door. The outer frame has a top, a bottom opposite and spaced apart from the top, a left side between the top and the bottom and a right side opposite and space-apart from the left side. The inner frame member is connected between the left and right outer frame sides at a location spaced apart from the bottom. The upper panel is disposed within the outer frame between the top and the inner frame member. This upper panel may be made of a transparent-material. The door panel may also preferably include a pet door installed within the opening formed between the inner frame member and the bottom of the outer frame.

### CROSS-REFERENCE TO RELATED APPLICATIONS

This application is a continuation-in-part of U.S. Provisional Application No. 61/078,860, filed Jul. 8, 2008 entitled “Sliding Glass Door Panel.”

### BACKGROUND OF THE INVENTION

Sliding glass door panels with a rough opening for a pet door are a known way to install a pet door in an existing sliding glass door track. However they are not securely permanent, are difficult and time consuming to install because of the many separate pieces involved, as well as many steps in the instructions to arrive at completion. Also once the panel is installed, the walk through width is made narrower and therefore human exit and entry is made more difficult.

Current patio door panels with pet doors installed, obstruct the opening of the existing sliding glass door after the patio panel is installed. Also the security on most patio doors arc compromised after the installation, because of the patio panels not being properly secured to the existing door frame work properly, or attaching to the existing sliding glass door in a secure manor as to lock it. Also installation of the more expensive patio doors on some require over 23 steps to install and are not consumer friendly for the home do it yourselfer.

### SUMMARY OF THE INVENTION

A preassembled, hinged, sliding glass door panel having an opening to install a pet door. The hinged feature can be secured to the existing vertical wall framing in a sliding glass door track, and to allow for the said panel to swing open or closed, and lock in place in either position, and receive the existing sliding glass door, to fasten to it. The preassembled feature allows for a faster, easier, more permanent, and stronger installation.

These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE DRAWINGS

FIG. 1A of the drawings is a front elevational perspective view of a door panel.

FIGS. 1B, 2A and 2B of the drawings are front elevational per spective views depicting steps of the door panel 300 of FIG. 1A being installed within a sliding glass door.

FIGS. 3A, 3B, 4A, and 4B of the drawings are front elevational perspective views of the door panel 300 of FIG. 1A in use within a sliding glass door.

FIG. 5 of the drawings is an exploded front elevational view of a pet door for installation in the door panel 300 of FIG. 1A, which has been installed within a sliding glass door.

FIGS. 6A and 6B of the drawings depict installation of an upper spacer bar between the door panel 300 and a sliding glass door as may be necessary in some installations.

FIG. 7A of the drawings is a perspective view of the door panel 300 of FIG. 1A being more permanently affixed to the door jamb wall frame.

FIG. 7B of the drawings is a back perspective view depicting the affixation of the door panel at multiple points to the door jamb wall frame.

FIG. 8A of the drawings is a perspective view of a portion of another embodiment of the door panel 300, which is installed to the exterior side of the sliding glass door.

FIG. 8B of the drawings is a perspective view of a portion of the embodiment of FIG. 8A further including an optional French Door lock.

FIGS. 9A and 9B of the drawings is a perspective view of the embodiment of FIG. 8A further including an optional lock to hold door panel 300 in an open position.

### DETAILED DESCRIPTION

With the preassembled, hinged, sliding glass door panel disclosed herein, these and other problems are addressed. With the hinged feature, the vertical hinge style may be directly secured via fasteners to the wall framing behind the existing sliding glass door, making for a more permanent installation. Also, because the preassembled hinged sliding glass door panel for a pet door, has most of the parts already assembled, the installation has fewer steps for the installer to follow, making installation faster and easier, more permanent, and stronger. When the existing active door of the sliding glass door is locked directly to the newly installed panel, the forces are transferred directly to the door jamb framing in the wall. Further, because the entire panel with the pet door installed, swings open and closed, and can be locked in either position, the option of “Full Width” exit and entrance can now be enjoyed.

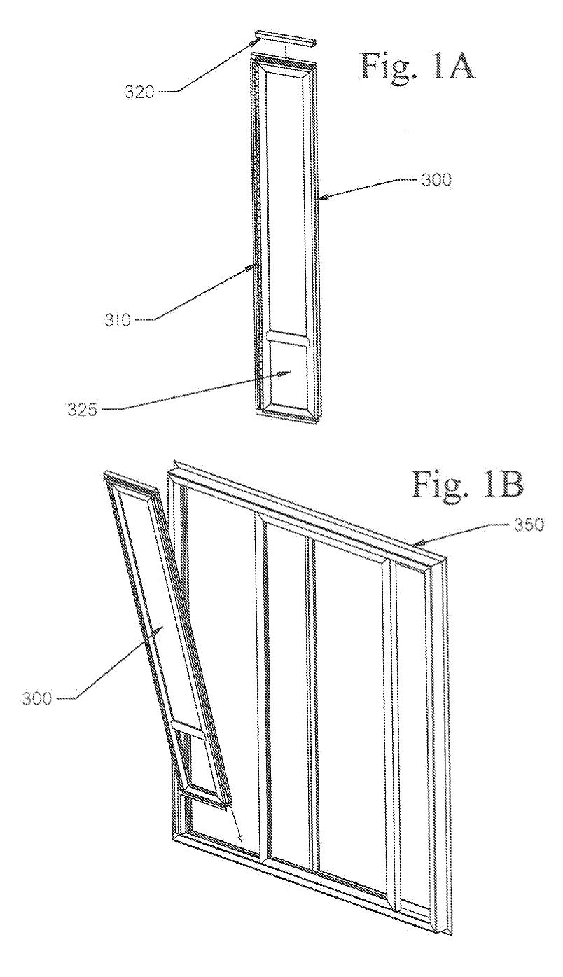

FIG. 1A, shows the preassembled, hinged, sliding glass door panel 300, with the upper spacer bar 320, used for final door height adjustment. In a preferred embodiment, hinge 310 is used to connect the sliding glass door panel 300 to the frame of the preexisting glass patio door 350. In the figures, hinge 310 is shown as a piano hinge, but it should be understood that other types of hinges may be used. The sliding glass door panel 300 also has a pet door rough opening 325.

FIG. 1B shows the preassembled, hinged, sliding glass door panel being installed into an existing sliding glass door track 350. It can also be seen in FIG. 1B, that sliding glass door panel 300 has two tongues in its bottom spaced-apart so as to correspond to the slots found in most pre-existing glass patio door assemblies 350 to provide further stability. The patio panel 300 is easy to install, and secure. It comes ready to place in a sliding glass door track, and directly fasten to the, existing vertical door jam. Then the threshold is secured by fasteners, and finally the top spacer to complete, an easy and very secure installation. After transferring over the current door latch receiver, the sliding glass door will be as secure as it was before the installation. Add a weather strip provided to the center door strut, and panel 300 is ready to operate.

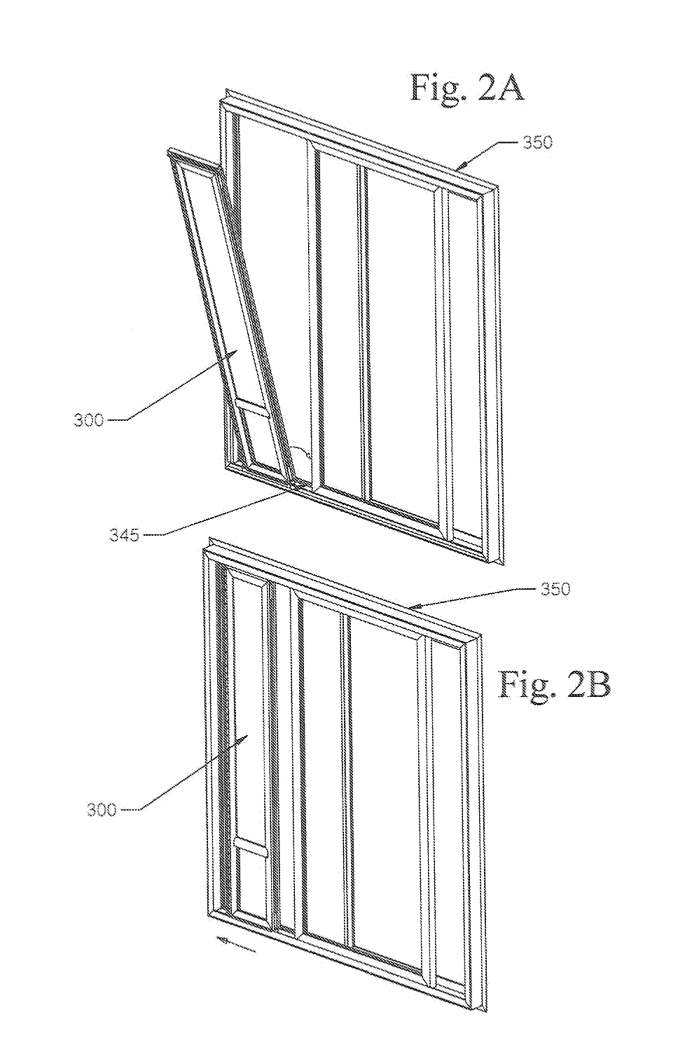

FIG. 2A shows the preassembled, hinged, sliding glass door panel in a further installation step, by placing it over the existing bottom track 345, and rotating it to vertical position shown in FIG. 2B.

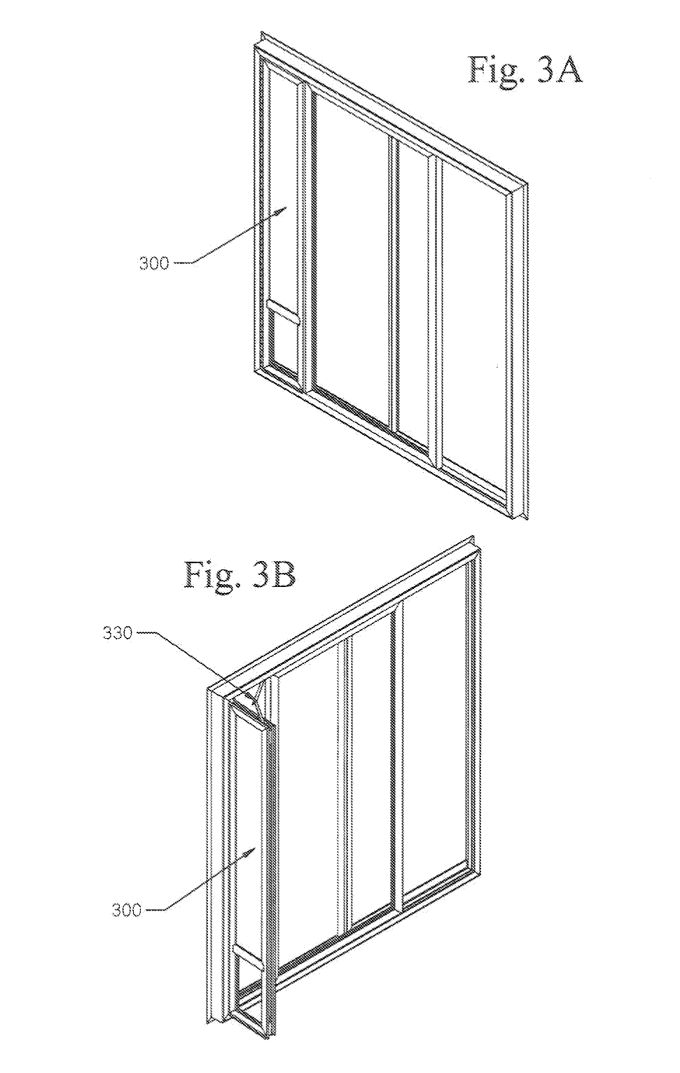

FIG. 3A shows the preassembled, hinged, sliding glass door panel in a final installed state.

FIG. 3B shows the panel in the open position, with one from of an optional (but preferred) “opening lock” shown as 330. As shown patio door opens to allow full width access to the sliding glass door opening by releasing the top and bottom French door type bolt, and opening the panel which swings on hinge 310 outward approximately ninety degrees. The panel is locked in the open position with an over center hinge arm. Release the hinge arm by pulling it inward, and close the patio panel 300, and relock the French door type bolts on the top and bottom.

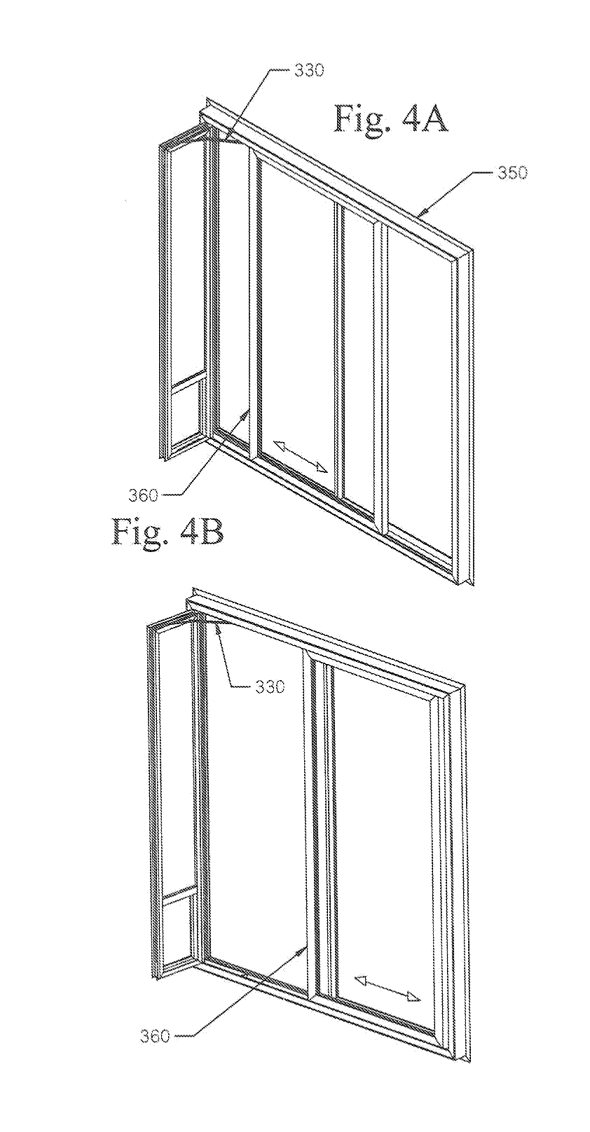

FIG. 4A, demonstrates how the sliding glass door 350, with the active door 360, can slide open or closed against, the preassembled, hinged, sliding glass door panel.

FIG. 4B, panel 360 is shown sliding open to clearly see that the human entry width, with the preassembled, hinged, sliding glass door panel also in the open and locked, 330, position, allows for the full width of the original available passage to be used.

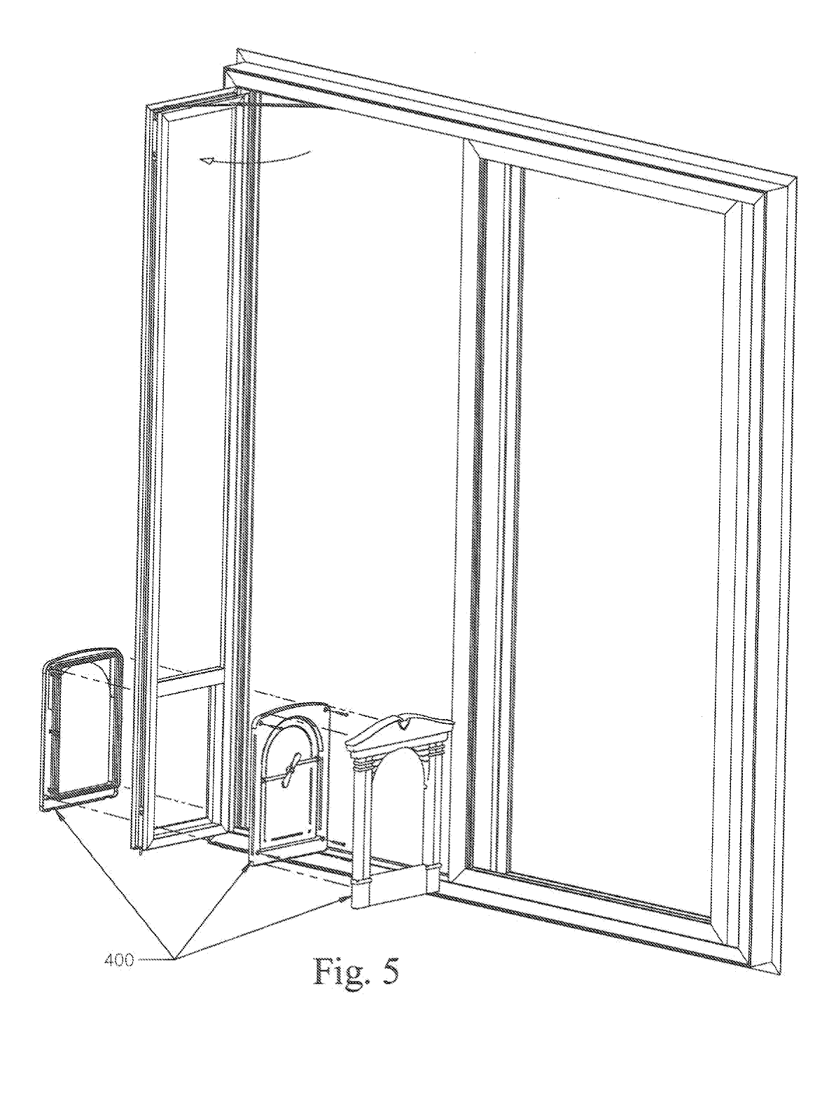

FIG. 5 shows a preferred pet door installation 400 being deployed within door rough opening 325.

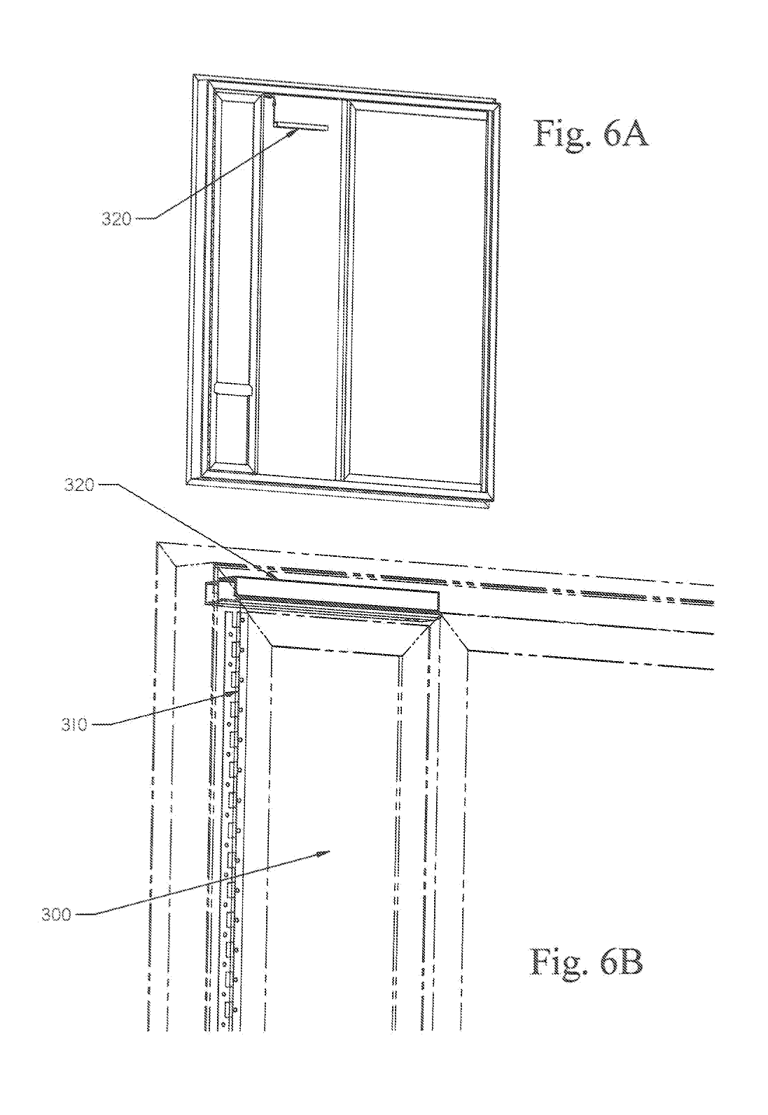

FIG. 6A with the upper spacer bar 320, ready to install.

FIG. 6B shows the panel 300, with hinge 310, and upper spacer bar 320, installed.

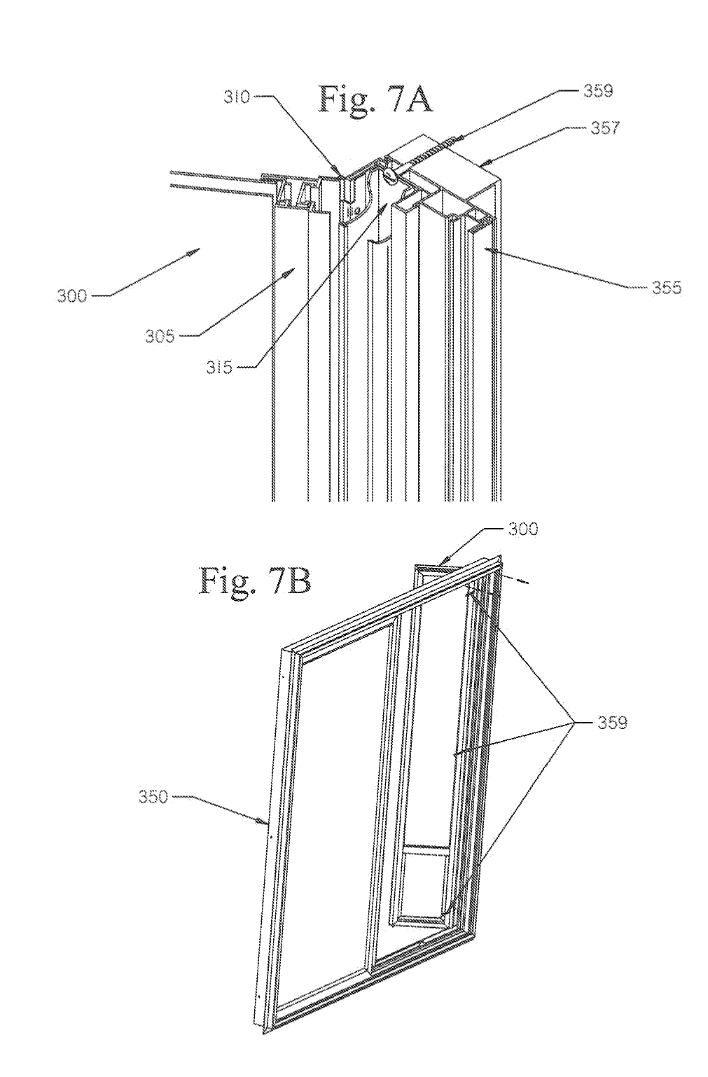

FIG. 7A demonstrates the vertical style 305 of panel 300, affixed to hinge 310, which is affixed to vertical mounting style 315, fastened through the existing sliding glass door frame 355, and secured with one version of a fastener 359, to the doorjamb wall framing 357.

FIG. 7B shows how multiple fasteners 359, could be used for a more permanent installation.

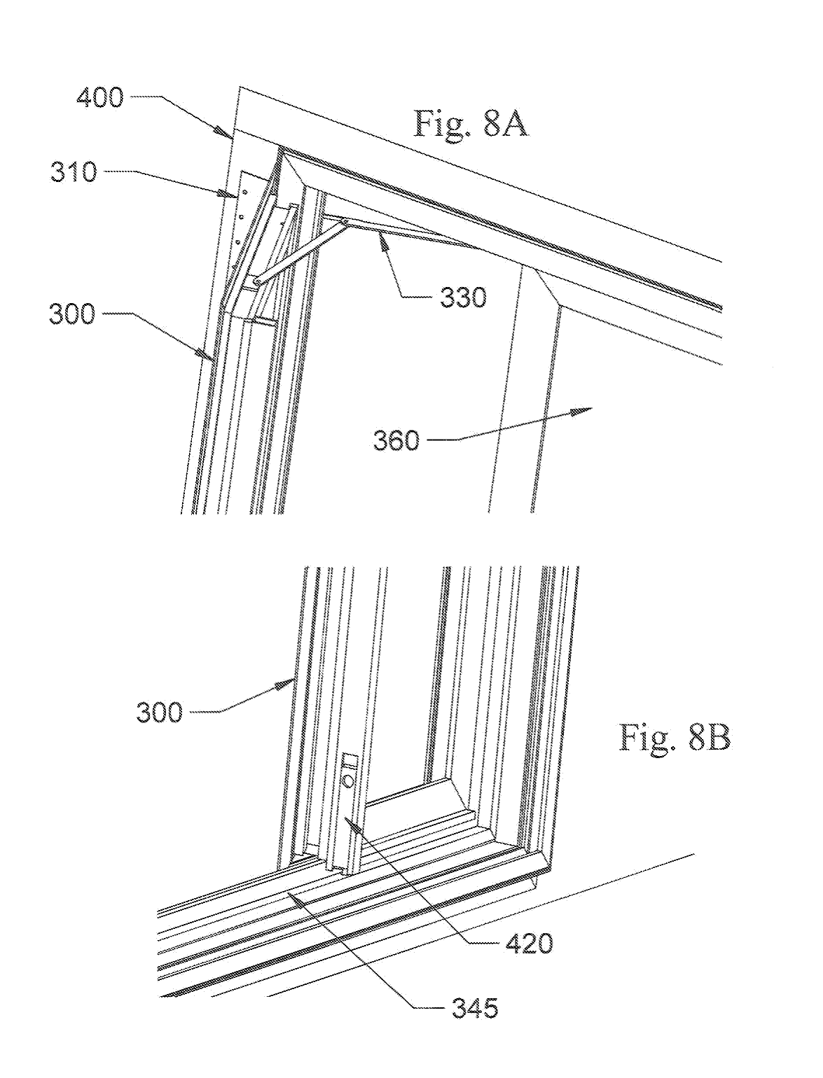

Unlike other embodiments, FIG. 8A, shows Panel 300 installed to the exterior side, of the existing sliding Glass Door, and fastened through the hinge 310, onto the exterior trim 400 or as required to the wall or framing. This embodiment in FIG. 8A, Panel 300 may be secured in an open position, with one form (but preferred) “opening lock” shown as 330, and opens in this form to approximately 90 degrees. An open and locked configuration of Panel 300, allows for the full original use and function of the original Sliding Glass Door, including use of the full passage width allowed by sliding panel 360. This is another desirable function not offered in preexisting patio pet door panels, especially given that the installation of this embodiment is quick and easy, and there are no alterations required to the function of the original Sliding Glass door. Also the Original Sliding Glass Door may have a screen door that slides parallel to panel 360. In this case the screen door may slide and seal against panel 300 when in the closed and locked position, and be fully returned to its original function when panel 300 is locked in any open position as described.

FIG. 8B shows Panel 300 in a closed position and secured to Track 345 with one form previously described using a French Door type bolt 420 to secure panel 300 to the top track and bottom track 345. With panel 300 locked in place to the track, Panel 360 can then slide and be secured and weather sealed to panel 300 by means of the latch on panel 360, and a like receiver to the latch on panel 300.

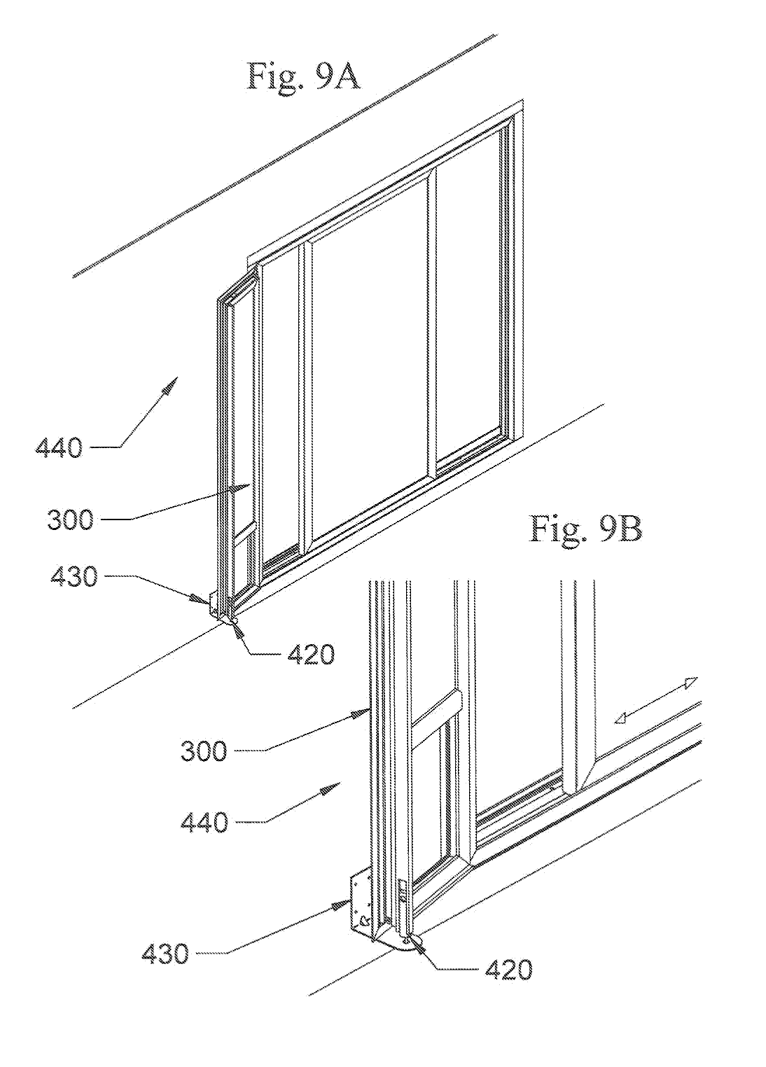

FIGS. 9A and 9B, shows another form to lock in the open position panel 300. This locking method shown in this form, utilizes the French Door type bolt 420 to fasten into a bracket 430 that is attached to an exterior wall 440. In this open and locked configuration panel 300 is swung open approximately 180 degrees and thus effectively and easily storing the panel 300 out of the way of human and pet traffic, locked against the wall 440 therefore creating a clear porch area for the full use and function of the existing Sliding Glass Door, and panel 360.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A door panel for use with a preexisting sliding type patio door, the preexisting sliding-type door having a bottom track, an upper door jamb, left and right vertical door jambs, a stationary patio door mounted between the bottom track and upper door jamb and a sliding patio door installed between the bottom track and upper door jamb, the door panel comprising:
an outer frame having a top, a bottom opposite and spaced apart from the top, a left side between the top and the bottom and a right side opposite and space-apart from the left side;
an inner frame member connected between the left and right outer frame sides at a location spaced apart from the bottom;
an upper panel disposed within the outer frame between the top and the inner frame member; and
means for connecting the outer frame to the preexisting sliding-type patio door.

2. The door panel according to claim 1 wherein the means for connecting the outer frame to the preexisting sliding-type patio door includes one or more fasteners between the left side of the outer frame and the left vertical door jamb of the preexisting sliding-type patio door.

3. The door panel according to claim 2 further including a pet door installed within an opening formed between the inner frame member and the bottom of the outer frame.

4. The door panel according to claim 1 wherein the means for connecting the outer frame to the preexisting sliding-type patio door includes a hinge connected between the left side of the outer frame and the left vertical door jamb of the preexisting sliding-type patio door.

5. The door panel according to claim 4 further including a pet door installed within an opening formed between the inner frame member and the bottom of the outer frame.

6. The door panel according to claim 5 further including an opening lock.

7. The door panel according to claim 1 wherein the means for connecting the outer frame to the preexisting sliding-type patio door includes one or more tongues protruding from an outer surface of the bottom of the outer frame toward and engaging the bottom track of the preexisting sliding-type patio door.
